(19) United States
(12) Patent Application Publication
(10) Pub. No.: US 2006/0178959 A1
(43) Pub. Date: Aug. 10, 2006

(54) System and method for controlling information flow in a revenue tracking system

(76) Inventor: Howard C. Cripe, Olathe, KS (US)

Correspondence Address: SPENCER, FANE, BRITT & BROWNE, 1000 WALNUT STREET, SUITE 1400, KANSAS CITY, MO, 64106-2140, US

(21) Appl. No.: 11/335,355

(22) Filed: Jan. 19, 2006

Related U.S. Application Data
(60) Provisional application No. 60/645,645, filed on Jan. 21, 2005.

(51) Int. Cl. G07F 19/00

(52) U.S. Cl. 705/30

(57) ABSTRACT

A mechanism and method for selectively excluding at least part of the information, such as, for example, revenue-related information, generated by one or more particular terminals or terminal types, or subsets of terminals or terminal types, from being considered or otherwise processed by revenue tracking software. More specifically, the present invention prevents the at least part of the information from being communicated over a network to the revenue tracking software, thereby avoiding adverse effects that would otherwise negatively impact, i.e., slow or stop, the flow of traffic on the network and the operation of the revenue tracking software. The present invention further allows for directing the at least part of the information to a memory or other software application.

### RELATED APPLICATIONS

The present patent application is a non-provisional patent application which is related to and claims priority benefit of an earlier-filed provisional patent application titled SYSTEM AND METHOD FOR EXCLUDING INFORMATION FROM CONSIDERATION BY REVENUE TRACKING SYSTEM, Ser. No. 60/645,645, filed Jan. 21, 2005. The identified provisional application is hereby incorporated by reference into the present non-provisional application.

### BACKGROUND OF THE INVENTION

1. Field of the Invention

The present invention concerns a mechanism and method for selectively excluding at least part of the information, such as, for example, revenue-related information, generated by one or more particular terminals or terminal types, or subsets of terminals or terminal types, from being considered or otherwise processed by revenue tracking software. More specifically, the present invention prevents the at least part of the information from being communicated over a network to the revenue tracking software, thereby avoiding adverse effects that would otherwise negatively impact the flow of traffic on the network and the operation of the revenue tracking software. The present invention further allows for directing the at least part of the information to a memory or other software application.

2. Background of the Invention

Revenue tracking systems receive or “pull” information from one or more terminals or types of terminals engaged in receiving or dispensing revenue in any of a variety of forms. Unfortunately, some such terminals or types of terminals sometimes provide such large or frequent amounts of information that the network carrying the information and the revenue tracking software processing it can be slowed significantly or even overwhelmed altogether.

For example, retail establishments are increasingly implementing different types of terminals, such as gas pump terminals, kiosks, or other dedicated terminals, some of which may not be balanced by the same revenue tracking system. Nevertheless, when a customer uses a gas pump and pays electronically at that pump, information regarding the transaction is sent as a sign-off record from the pump terminal point-of-sale interface to the revenue tracking software via a local area network. The frequency or size of these sign-off records can eventually slow the network or revenue tracking software significantly or even overwhelm them altogether due to the amount of bandwidth and processing needed for each sign-off record, particularly when the information is received in real-time.

### SUMMARY OF THE INVENTION

The present invention provides a mechanism and method for selectively excluding at least part of the information, such as, for example, revenue-related information, generated by one or more particular terminals or terminal types, or subsets of terminals or terminal types, from being considered or otherwise processed by the revenue tracking software. More specifically, the present invention prevents the at least part of the information from being communicated over the network to the revenue tracking software, thereby avoiding adverse effects that would otherwise negatively impact, i.e., slow or stop, the flow of traffic on the network and the operation of the revenue tracking software.

In a revenue tracking system comprising revenue tracking software; a plurality of terminals, with each terminal being operable to generate revenue-related information; and a network operable to communicate the revenue-related information generated by the two or more terminals to the revenue tracking software, the mechanism of the present invention allows a user to identify a particular terminal of the plurality of terminals and allows the user to selectively prevent at least part of the revenue-related information generated by the particular terminal from being communicated to the revenue tracking software over the network.

The present invention can alternatively be characterized as a method of selectively excluding information generated by a particular terminal from consideration by a revenue tracking software, comprising the steps of allowing a user to electronically identify the particular terminal, from among a plurality of terminals, that is generating the information to be excluded from consideration by the revenue tracking software, and allowing the user to electronically selectively exclude at least some part of the information generated by the particular terminal from being considered by the revenue tracking software.

In various contemplated embodiments, the mechanism and method further allow the user to identify the at least part of the information to be excluded; to identify a type of terminal or range of terminals to be excluded, wherein the particular terminal is an instance of the type of terminal or is within the range of terminals; and/or to direct the at least some part of the information to a memory for storage or to a software application which is not the revenue tracking software.

These and other important aspects of the present invention are more fully described in the detailed description set forth below.

### BRIEF DESCRIPTION OF THE DRAWING FIGURES

A preferred embodiment of the present invention is described in detail below with reference to the attached drawing figures, wherein:

FIG. 1 is a block diagram of a preferred embodiment of the mechanism of the present invention incorporated into a revenue tracking system; and

FIG. 2 is a flowchart of steps involved in operation of the mechanism within the revenue tracking system of FIG. 1.

### DETAILED DESCRIPTION OF THE PREFERRED EMBODIMENT

With reference to the figures, a mechanism and method is described, shown, and otherwise disclosed herein in accordance with a preferred embodiment of the present invention. Broadly, the present invention provides a mechanism and method for selectively excluding at least part of the information, such as, for example, revenue-related information, generated by one or more particular terminals or terminal types, or subsets of terminals or terminal types, from being considered or otherwise processed by revenue tracking software. More specifically, the present invention prevents the at least part of the information from being communicated over a network to the revenue tracking software, thereby avoiding adverse effects that would otherwise negatively impact, i.e., slow or stop, the flow of traffic on the network and the operation of the revenue tracking software.

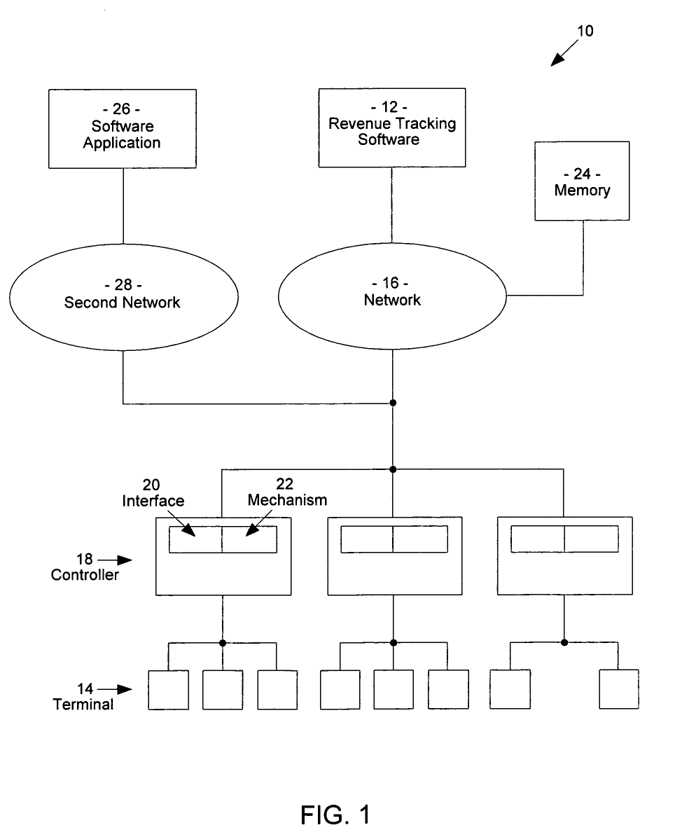

Referring to FIG. 1, a large retail establishment offering a variety of different products and services will typically use a revenue tracking system 10 to track changes in revenue in real-time throughout the establishment. To accomplish this, the revenue tracking system 10 includes revenue tracking software 12 that receives and then processes information, including revenue-related information, generated by one or more terminals 14 engaged in receiving or dispensing the revenue. The present invention may be incorporated into such a revenue tracking system 10, existing or new, comprising a number of different components, any of which may, as appropriate, be implemented in hardware, firmware, software, or any combination thereof. An exemplary revenue tracking system and software into which the present invention may be incorporated is disclosed in U.S. Pat. No. 6,772,941, titled REVENUE BALANCING METHOD AND COMPUTER PROGRAM, issued Aug. 10, 2004, which describes a version of a product available from Balance Innovations, LLC, of Lenexa, Kans., and which is hereby incorporated by reference into the present application. It will be understood and appreciated, however, that the present invention may be used with substantially any revenue tracking system or software and is not limited to use with the identified exemplary system and software.

The revenue tracking software 12 communicates via the electronic network 16 with the one or more terminals 14, each of which generates information, including revenue-related information. The network 16 may be, for example, a local area network (LAN) or a wide area network (WAN), such as the Internet. Each terminal 14 is assigned an alphanumeric or other identifier used to identify the terminal 14 to the other components of the revenue tracking system 10, particularly the revenue tracking software 16. Each terminal 14 is also operably associated with a dedicated or shared point-of-sale controller 18, and each controller 18 is associated with an interface 20. The controller 18 and interface 20 control communication of the terminal's identifier and generated information via the electronic network 16 to the revenue tracking software 12 for processing.

The aforementioned large retail establishment will typically have dozens or perhaps hundreds of such terminals 14 from which revenue may be received, dispensed, or merely exchanged. These terminals 14 may include, for example, manned cashier terminals; substantially automated self-checkout terminals; vending machines; coin-redemption machines; lottery machines; gas pump terminals; pay telephones; kiosks of various types; and automated car wash terminals. Certain of the terminals, such as, for example, some or all of the vending machines or pay telephones, may be owned, leased, or otherwise managed by third-parties, and therefore it may be neither necessary nor desirable for the revenue tracking software 16 to receive information from these terminals. Similarly, certain of the terminals, such as, for example, the gas pump terminals, even if managed by the retail establishment, may be balanced or otherwise revenue-tracked by one or more different systems or software, and therefore it may be neither necessary nor desirable for the revenue tracking software 16 to receive revenue-related information from these terminals either. Furthermore, receiving such information, apart from being unnecessary or undesirable, may significantly slow or overwhelm the revenue tracking system 10.

The present invention provides a mechanism 22 for allowing an administrator or other authorized person to exclude part or all of the information generated by one or more of the terminals 14 from consideration by the revenue tracking software 16. The mechanism 22 acts as a filter of the identified information generated by the identified terminal, and may be implemented in hardware, firmware, software, or any combination thereof. In various contemplated embodiments, the mechanism 22 is incorporated into or otherwise associated with some or all of the terminals 14, some or all of the point-of-sale controllers 18, or some or all of the interfaces 20. In one such embodiment, for example, the mechanism 22 instructs the one or more point-of-sale controllers 18 associated with the one or more terminals identified for exclusion to ignore, not process, or otherwise filter part or all of the revenue-related information generated by those terminals such that the part or all of the revenue-related information is not considered by the revenue tracking software 12. This is accomplished, in one embodiment, by not sending the information as traffic over the electronic network 16 at all, thereby avoiding the adverse effects that would otherwise negatively impact overall operation of the revenue tracking system 10.

At least some part of each identifier may associate the identified terminal with a subset of terminals that are similar in some relevant way, such as, for example, the subset of terminals associated with gas pumps, vending machines owned by third-parties, or particular departments within the establishment. Alternatively, such subsets of terminals may be assigned sequential identifiers. In either case, it is possible, in a contemplated embodiment of the present invention, to identify a type of terminal or a range of terminals rather than individual terminals when large numbers of terminals are to be excluded.

Also, in a contemplated embodiment, the mechanism 22 is adapted to direct the excluded part or all of the information to one or more memories 24 or to one or more internal, external, or third-party software applications 26, such as, for example, a database or second revenue tracking software, other than the primary revenue tracking software 12 of the revenue tracking system 10. Such direction may take place over the primary network 16 or over a different network 28. Furthermore, the one or more memories 24 or software applications 26 are accessible to the revenue tracking software 12 such that the excluded information, either in its original or a post-processing form, can be accessed by the revenue tracking software 12. Thus, for example, the initially excluded information may be stored in the memory 24 and subsequently accessed for processing at a time when more processing or communication resources are available, such as, for example, after normal business hours. In another example, the initially excluded information may be directed to and processed by the software 26, which may be another revenue tracking program, and subsequently accessed, possibly in a post-processed form which requires less network resources and/or processing by the primary revenue tracking software 12.

The mechanism 22 can be incorporated into or otherwise act at any appropriate point in the revenue tracking system 10. As mentioned, in a contemplated embodiment, the mechanism 22 is incorporated into or otherwise acts at the interface 20, but, in other embodiments, could be incorporated into or otherwise act at the terminal 14 or the point-of-sale controller 18, so as to prevent the information from being communicated as traffic over the network 16, thereby preventing a slowing or stopping of network traffic. Alternatively, the mechanism 22 can be incorporated or otherwise act at the revenue tracking software 12 itself. This latter implementation would presumably not prevent a slowing of network traffic, but would still prevent a slowing of operation by the revenue tracking software 12.

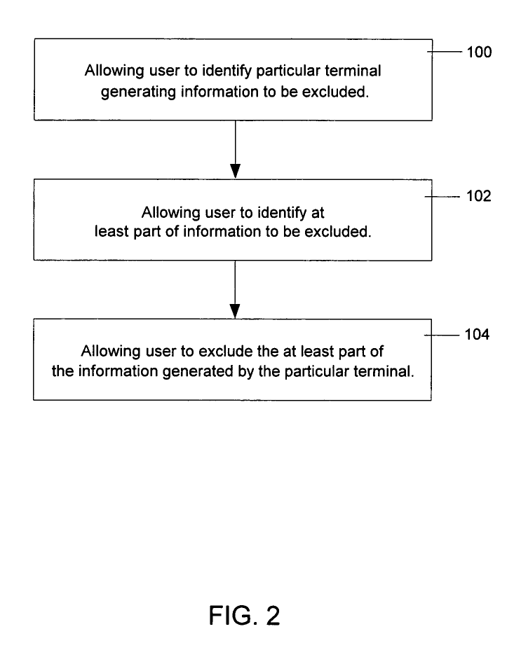

Referring to FIG. 2, the present invention is alternatively characterized as a method of selectively excluding information generated by a particular terminal from consideration by a revenue tracking software, comprising the following steps. Initially, a user is allowed to electronically identify the particular terminal, individually, by type, or by range, from among a plurality of terminals, that is generating the information to be excluded from consideration by the revenue tracking software, as shown in box 100. The user may also be allowed to identify some part of the information generated by the identified particular terminal for exclusion, as shown in box 102. The user is then allowed to electronically selectively exclude the information, or the identified part of the information, generated by the identified particular terminal from being considered by the revenue tracking software, as depicted in box 104. In one contemplated embodiment, the user is also allowed to direct the excluded information, or identified part of the information, to a memory or other software application, as shown in box 106.

The present invention is alternatively characterized as a computer program, or combination of computer instructions, operable to perform the method of the present invention, as shown in FIG. 2.

Thus, in first exemplary use and operation, and not by way of limitation, the present invention may be implemented and may function as follows. An administrator or other authorized person determines that the revenue-related information generated by particular terminals within a large retail establishment should not be considered by the store's revenue tracking software 12. The person provides the identifiers assigned to those terminals to the mechanism 22 of the present invention incorporated into the one or more interfaces 20 associated with the one or more point-of-sale controllers 18 controlling communication of the revenue-related information to the revenue tracking software 12, so as to instruct the one or more interfaces 20 to ignore or otherwise filter this information so that the information is not communicated as traffic over the network 16. If it subsequently happens that the person wishes to change the list of excluded terminals, or the part or all of the information that is excluded, then the person need only enter the corresponding changes into the mechanism 22.

In second exemplary use and operation, and not by way of limitation, the present invention may be implemented and may function as follows. An administrator or other authorized person determines that part or all of the revenue-related information generated by a number of terminals of a particular type within a large retail establishment should not be considered by the store's primary revenue tracking software 12, but should instead be directed to a memory 24 or other software application 26. The person provides the range of identifiers assigned to terminals of this type to the mechanism 22 of the present invention incorporated into the one or more interfaces 20 associated with the one or more point-of-sale controllers 18 controlling communication of the revenue-related information to the primary revenue tracking software 12, so as to instruct the one or more interfaces 20 to direct this information to the memory 24 or other software application 26. The revenue tracking software 12 can subsequently access the information, either its original or a post-processing form.

From the preceding description, it will be appreciated that the system and method of the present invention provide a number of substantial advantages, including, for example, avoiding adverse effects resulting from the receipt and processing of large or frequent amounts of unnecessary and undesired information that would otherwise negatively impact operation of the revenue tracking system.

Although the invention has been described with reference to the preferred embodiments, it is noted that equivalents may be employed and substitutions made herein without departing from the contemplated scope of the invention.

1. In a revenue tracking system in which two or more terminals are each operable to generate information for communication to a revenue tracking software, the improvement comprising:
a mechanism for allowing a user to identify a particular terminal of the two or more terminals and to allow the user to selectively prevent the revenue tracking software from considering at least part of the information generated by the particular terminal.

2. The revenue tracking system as set forth in claim 1, wherein the at least part of the information includes revenue-related information.

3. The revenue tracking system as set forth in claim 1, wherein the mechanism further allows the user to identify the at least part of the information to be excluded.

4. The revenue tracking system as set forth in claim 1, wherein the mechanism further allows the user to identify a type of terminal, wherein the particular terminal is an instance of the type of terminal.

5. The revenue tracking system as set forth in claim 1, where the mechanism further allows the user to identify a range of terminals, wherein the particular terminal is within the range of terminals.

6. The revenue tracking system as set forth in claim 1, wherein the mechanism prevents communication of the at least some part of the information to the revenue tracking software.

7. The revenue tracking system as set forth in claim 1, wherein the mechanism causes the at least some part of the information to be filtered.

8. The revenue tracking system as set forth in claim 1, wherein the mechanism further allows the user to direct the at least some part of the information to a memory for storage.

9. The revenue tracking system as set forth in claim 1, wherein the mechanism further allows the user to direct the at least some part of the information to a software application which is not the revenue tracking software.

10. A revenue tracking system comprising:
revenue tracking software;
two or more terminals, with each terminal being operable to generate revenue-related information;
a network operable to communicate the revenue-related information generated by the two or more terminals to the revenue tracking software; and
a mechanism for allowing a user to identify a particular terminal of the two or more terminals and to allow the user to selectively prevent at least part of the revenue-related information generated by the particular terminal from being communicated to the revenue tracking software over the network.

11. The revenue tracking system as set forth in claim 10, wherein the mechanism further allows the user to identify the at least part of the information to be excluded.

12. The revenue tracking system as set forth in claim 10, wherein the mechanism further allows the user to identify a type of terminal, wherein the particular terminal is an instance of the type of terminal.

13. The revenue tracking system as set forth in claim 10, where the mechanism further allows the user to identify a range of terminals, wherein the particular terminal is within the range of terminals.

14. The revenue tracking system as set forth in claim 10, wherein the mechanism causes the at least some part of the information to be filtered.

15. The revenue tracking system as set forth in claim 10, wherein the mechanism further allows the user to direct the at least some part of the information to a memory for storage.

16. The revenue tracking system as set forth in claim 10, wherein the mechanism further allows the user to direct the at least some part of the information to a software application which is not the revenue tracking software.

17. The revenue tracking system as set forth in claim 10, further including a controller and an interface associated with the particular terminal for controlling communication of the information from the particular terminal to the revenue tracking software over the network, and wherein the mechanism is incorporated into the interface.

18. A revenue tracking system comprising:
revenue tracking software stored on a storage media and executed on a computing device;
a plurality of cash register terminals and a plurality of gas pump terminals, with the plurality of cash register terminals and the plurality of gas pump terminals being operable to generate revenue-related information;
an electronic network connecting the plurality of cash register terminals and the plurality of gas pump terminals with the computing device, and operable to communicate the revenue-related information generated by the plurality of cash register terminals and the plurality of gas pump terminals to the revenue tracking software; and
a mechanism for allowing a user to identify the plurality of gas pump terminals and to allow the user to selectively prevent at least part of the revenue-related information generated by the plurality of gas pump terminals from being communicated to the revenue tracking software over the electronic network.

19. A method of selectively excluding information generated by a particular terminal from consideration by a revenue tracking software, the method comprising the steps of:
(a) allowing a user to electronically identify the particular terminal, from among two or more terminals, that is generating the information to be excluded from consideration by the revenue tracking software; and
(b) allowing the user to electronically selectively exclude at least some part of the information generated by the particular terminal from being considered by the revenue tracking software.

20. The method as set forth in claim 19, wherein the at least some part of the information includes revenue-related information.

21. The method as set forth in claim 19, wherein step (a) further includes allowing the user to identify the at least some part of the information to be excluded.

22. The method as set forth in claim 19, wherein step (a) includes allowing the user to identify a type of terminal, wherein the particular terminal is an instance of the type of terminal.

23. The method as set forth in claim 19, where step (a) includes allowing a user to identify a range of terminals, wherein the particular terminal is within the range of terminals.

24. The method as set forth in claim 19, wherein step (b) includes not communicating the at least some part of the information to the revenue tracking software.

25. The method as set forth in claim 19, wherein step (b) includes filtering the at least some part of the information.

26. The method as set forth in claim 19, further including the step of allowing the user to direct the at least some part of the information to a memory for storage.

27. The method as set forth in claim 19, further including the step of allowing the user to direct the at least some part of the information to a software application which is not the revenue tracking software.

28. A method of selectively excluding revenue-related information generated by a particular terminal from consideration by a revenue tracking software, the method comprising the steps of:
(a) allowing a user to electronically identify the particular terminal, from among two or more terminals, that is generating the revenue-related information to be excluded from consideration by the revenue tracking software; and
(b) allowing the user to electronically selectively prevent at least some part of the revenue-related information from being communicated over a network to the revenue tracking software.

29. The method as set forth in claim 28, wherein step (a) further includes allowing the user to identify the at least some part of the revenue-related information to be excluded.

30. The method as set forth in claim 28, wherein step (a) includes allowing the user to identify a type of terminal, wherein the particular terminal is an instance of the type of terminal.

31. The method as set forth in claim 28, where step (a) includes allowing the user to identify a range of terminals, wherein the particular terminal is within the range of terminals.

32. The method as set forth in claim 28, wherein step (b) includes filtering the at least some part of the information.

33. The method as set forth in claim 28, further including the step of allowing the user to direct the at least some part of the information to a memory for storage.

34. The method as set forth in claim 28, further including the step of allowing the user to direct the at least some part of the information to a software application which is not the revenue tracking software.

35. A computer program for selectively excluding revenue-related information generated by a particular terminal from consideration by a revenue tracking software, with the computer program being stored on one or more storage medias and executed by one or more computing devices, the computer program comprising:
a first code segment allowing a user to electronically identify the particular terminal, from among two or more terminals, that is generating the revenue-related information to be excluded from consideration by the revenue tracking software; and
a second code segment allowing the user to electronically selectively prevent at least some part of the revenue-related information from being communicated over a network to the revenue tracking software.

36. The computer program as set forth in claim 35, wherein the first code segment further allows the user to identify the at least some part of the revenue-related information to be excluded.

37. The computer program as set forth in claim 35, wherein the first code segment further allows the user to identify a type of terminal, wherein the particular terminal is an instance of the type of terminal.

38. The computer program as set forth in claim 35, where the first code segment further allows the user to identify a range of terminals, wherein the particular terminal is within the range of terminals.

39. The computer program as set forth in claim 35, further including a third code segment allowing the user to direct the at least some part of the information to a memory for storage.

40. The computer program as set forth in claim 35, further including a third code segment allowing the user to direct the at least some part of the information to a software application which is not the revenue tracking software.
